(19) United States
(12) Patent Application Publication
(10) Pub. No.: US 2006/0151664 A1
(43) Pub. Date: Jul. 13, 2006

(54) Power transmission device

(76) Inventors: Jiahua Yu, Shanghai (CN); Ji Yu, Shanghai (CN); Minjie He, Shanghai (CN); Yu Chen, Shanghai (CN); Lin Li, Shanghai (CN); Xiaozhen Qiu, Shanghai (CN)

Correspondence Address: Raymond Y. Chan, Suite 128, 108 N. Ynez Ave., Monterey Park, CA, 91754, US

(21) Appl. No.: 11/281,522

(22) Filed: Nov. 16, 2005

(30) Foreign Application Priority Data
Nov. 16, 2004 (CN) 200410084216.7
May 30, 2005 (CN) 200510074595.6
Nov. 8, 2005 (CN) 200510119830.7

(51) Int. Cl. B64C 39/02; B63H 13/00; B64C 39/00; B63H 9/00; B64C 29/00

(52) U.S. Cl. 244/4 R; 440/8

(57) ABSTRACT

The present invention discloses a power transmission device, including a revolution shaft, a power transmission frame wheel rotatably and coaxially coupled to the revolution shaft, a plurality of spinning shaft symmetrically provided at outside edges of the power transmission frame. A plural of blades rotatably and coaxially coupled to respective spinning shaft, and a blade rotating arrangement connected to respective spinning shaft for managing a rotational direction and speed of the blades, such that when the revolution shaft is powered to rotate driving the power transmission frame into rotation, the spinning shaft provided at outer edges of the power transmission frame are capable of being rotated with a reversed direction with speed ratio of 1:2 for maximizing the wind bearing size of the blade in wind favorable condition and decreasing the wind bearing size in wind undesirable condition.

### BACKGROUND OF THE PRESENT INVENTION

1 Field of Invention

The present invention relates to power transmission devices applied for wind energy or hydraulic energy output and input, and more particularly, relates to power generator, flapping wing helicopter, hydrating generator, as well as vessels equipped with such kind of power transmission devices in varying applications.

2. Description of Related Arts

The key point of the power transmission device which utilizes the blade to output or input the wind power or hydraulic power is to substantially enlarge the wind-bearing size or water-bearing size while the device is positioned at a wind favorable position, while substantially minimize the bearing area in upwind position. In conventional propeller-type power transmission device, the turbine blades are commonly prepared with spiral shaped with a predetermined curvature. This is due to the fact that such spiral shaped blade would withstand greater stress in service at the wind favorable position. Unfortunately, when such device is disposed at a wind withstanding position, the resistance force of the blades would be correspondingly increased as well thus worsening the overall efficiency.

As disclosed in China patent numbered as 2067768, Dec. 19, 1990, titled as windmill with revolution and rotatable blades, and categorized as No. F03D3/00. Such windmill is adapted to be used in wind energy utilization purposes, wherein the windmill comprises a plurality of blades 1, a main shaft 2, a blade rotation shaft 3, a catch pin 4, an upper frame 5, a lower frame 6, a gear box 7, a generator 8, and a base 17. Due to the fact that the blade is not symmetrically disposed at two sides of the rotation shaft, the thicker side of the blade would withstand stronger wind thus forcing the blade biasing against the catch pin in the wind favorable position, and being disengaged with the catch pin in the wind backup position. Furthermore, such windmill could be prepared with cheaper cost and relatively simple structure, and more importantly, such windmill is capable of driving the piston-type water pump to facilitate the irrigation as well as assist the generator. However, during the operation, the catch pin would withstand substantial force regardless of the wind condition. On the other hand, the variance of the blade's movement is much higher. The blades are free to shift within a wide range of space, thus making enormous noise in practices.

Moreover, the helicopters currently serviceable in the market are employing fixed wings mechanism. Such fixed wings design has been proven to have a smaller air withstanding area, and a weak lifting torque. Therefore, a flapping wing helicopter has attracted so much attention and been prospective within the art.

Currently, the hydrant generators unexceptionally employ turbine for converting hydrant power into electrical power, wherein the high speed water torrent is directed to impact onto the turbine. Nevertheless, the turbine blade would withstand substantial bearing force under an against-current condition, thus wasting the power outputting efficiency. On the other hand, current ship utilize the fuel driven mechanic to operate the propeller, which cause unnecessary energy consumption, and pollution.

### SUMMARY OF THE PRESENT INVENTION

A primary object of the present invention is to provide a power transmission device, which utilize the blade to output/input the wind energy or hydraulic energy, wherein the blades of the power transmission device is capable of providing a maximum servicing area in wind/water favorable position, and exposing a minimum bearing area in wind/water invert position.

Another object of the present invention is to provide a wind generator employing above power transmission device and a utilizing method thereof, wherein the blades of the power transmission device is capable of providing a maximum servicing area in wind/water favorable position, and exposing a minimum bearing are in wind/water invert position.

Another object of the present invention is to provide a flapping-wing helicopter which employs above mentioned power transmission device, wherein the blades of the helicopter is capable of providing a maximum servicing area in wind/water head position, and exposing a minimum bearing are in wind/water invert position.

Another object of the present invention is to provide a hydraulic generator which employs above mentioned power transmission device, wherein the blades of the power transmission device is capable of providing a maximum servicing area in wind/water favorable position, and exposing a minimum bearing are in wind/water invert position.

Another object of the present invention is to provide a ship equipped with the above mentioned power transmission device, wherein the blades of the power transmission device is capable of providing a maximum servicing area in wind/water favorable position, and exposing a minimum bearing are in wind/water invert position.

Accordingly, to achieve above mentioned objects, the present invention provides a power transmission device, comprising:

a revolution shaft;

a power transmission frame wheel rotatably and coaxially coupled to the revolution shaft, comprising a plurality of spinning shaft symmetrically provided at outside edges of the power transmission frame;

a plural of blades rotatably and coaxially coupled to respective spinning shaft; and

a blade rotating arrangement connected to respective spinning shaft for managing a rotational direction and speed so as to ensure the spinning shafts rotated reversed with respect to the revolution shaft at a speed ratio 1:2, such that when the revolution shaft is powered to rotate driving the power transmission frame into rotation, the blades will correspondingly rotated to maximize a wind bearing size of the blade in wind favorable condition and minimize the wind bearing size in wind undesirable condition.

These and other objectives, features, and advantages of the present invention will become apparent from the following detailed description, the accompanying drawings, and the appended claims.

### BRIEF DESCRIPTION OF THE DRAWINGS

FIG. 1 is a sectional view showing the structure of a wind energy generator according to a preferred embodiment of the present invention.

FIG. 2 is a sectional view illustrating the structure of a wind energy generator according to a second preferred embodiment of the present invention.

FIG. 3 is a schematic view demonstrating the initial phase angle of the blades of the above-preferred embodiment of the present invention.

FIG. 4 is a schematic view demonstrating the blade is positioned at four key points.

FIG. 5 is a sectional view showing a wind energy generator according a third preferred embodiment of the present invention.

FIG. 6 is a sectional view showing the rotation axis of the blade is perpendicularly orientated with the wind direction and parallel with respect to the horizontal direction.

FIG. 7 is a schematic view showing a ship prepared with the power transmission device according to the preferred embodiment of the present invention.

FIG. 8 is a schematic view showing a flapping wing aircraft equipped with the power transmission device according to the preferred embodiment of the present invention.

FIG. 9 is a front view showing a flapping wing aircraft equipped with the power transmission device according to the preferred embodiment of the present invention.

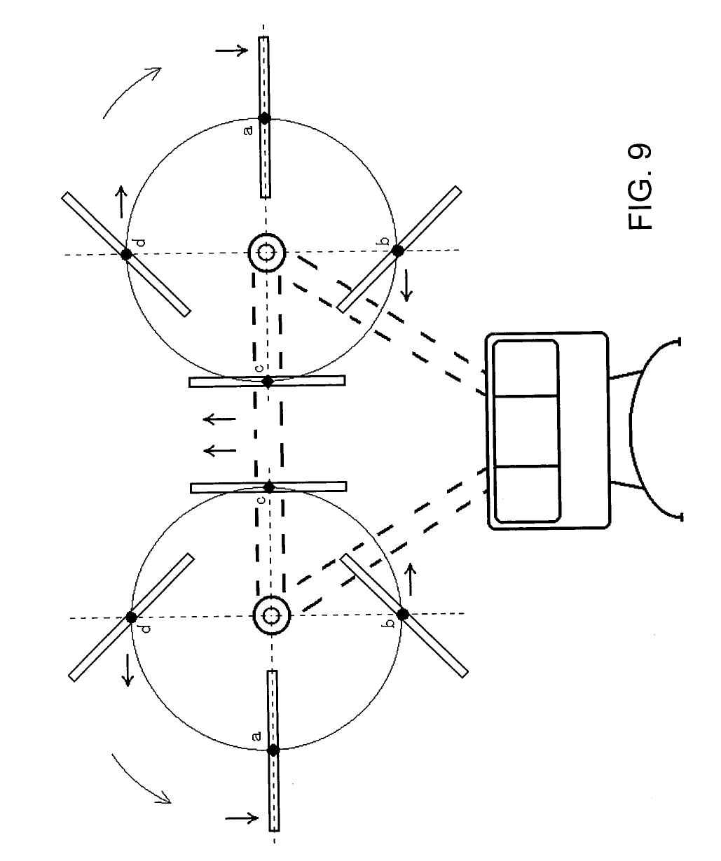

### DETAILED DESCRIPTION OF THE PREFERRED EMBODIMENT

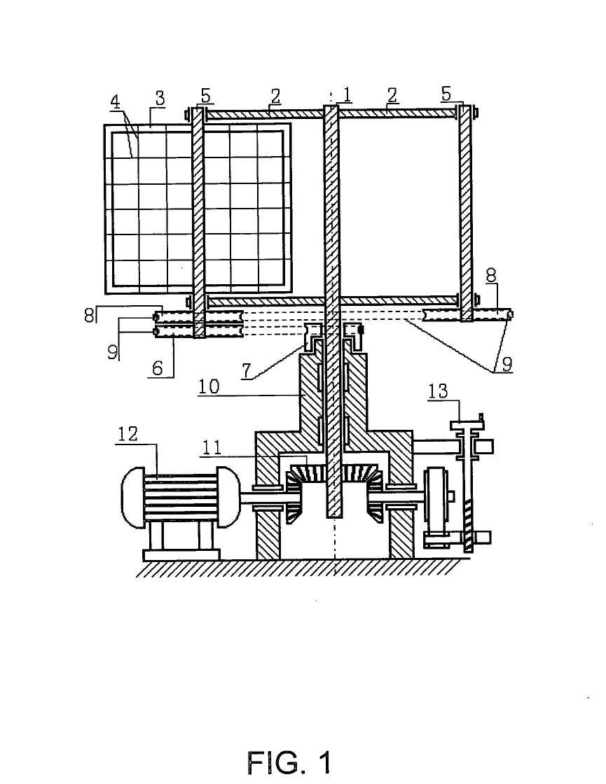

Referring to FIG. 1, a power transmission device according to a preferred embodiment of the present invention is illustrated. The power transmission device comprises a revolution shaft, a power transmission frame rotatably and coaxially coupled to the revolution shaft, comprising a plurality of spinning shaft symmetrically provided at outside edges of the power transmission frame; a plural blades rotatably and coaxially coupled to respective spinning shaft; and a blade rotating arrangement connected to respective spinning shaft for managing a rotational direction and speed, such that when the revolution shaft is power to rotate driving the power transmission frame to rotate, the spinning shaft provided at outer edges of the power transmission frame are capable of being rotated with a reversed direction, wherein the rotating speed ratio between the spinning shaft and the revolution shaft is 1:2.

In other words, the power transmission devices comprises a plurality of blades, a plurality of spinning shafts for accommodating the blades, a power transmission frame wheel for supporting the above blades and spinning shafts, and a revolution shaft for supporting the power transmission frame wheel in position. Accordingly, the revolution shaft is coaxially disposed at a center portion of the power transmission frame wheel with a secured manner. And preferably, four blades are respectively provided at four corners of the power transmission frame wheel, wherein each of the blades is coaxially coupled to respective spinning shafts. It is noted that the blades could be integrally formed with respective spinning shaft or directly soldered onto such spinning shaft. As a result, the spinning shafts would be revolutionarily shifted with respect to the revolution shaft and simultaneously self rotating as well in practice. Furthermore, the power transmission device comprises a blade rotating arrangement, comprising a revolution shaft bush, a revolution gear set mounted onto the revolution shaft bush, a spinning gear set provided onto a spinning shaft and a plurality of spinning shaft synchronizing gear coupled onto the spinning shafts, wherein the revolution gear set and the spinning gear set are transmitted via an annular teeth belt, different spinning shaft synchronic gears are transmitted via another annular teeth belt. It is noted that the revolution gear set and the spinning gear set has a transmission ratio of 1:2. Thanks to above mentioned blade rotating arrangement, the blade revolution shaft and the blade spinning shaft could have a reversed rotational direction. And the rotation speed ratio between the blade spinning shaft and the blade revolution shaft is 2:1.

As shown in FIG. 1, the revolution shaft 1 is fixed onto the power transmission frame wheel 2, and the blade spinning shaft 5 is rotatably mounted to the outer edge of the power transmission frame wheel 2. And the spinning shaft 5 is coaxially disposed at the central portion of the blade 3 with a secured manner. Moreover, the blade 3 further comprises a plurality of reinforcement ribs interweaved within the blade 3 it is worth to mention that the density of such reinforcement ribs would determine the overall structure intensity of the blade 3. As a result, the reinforcement ribs could be prepared with punched steel web or other materials. The blade spinning shaft 5 and the blade spinning gear 6 are fixedly coupled with each other. The wind direction rudder rotation ring gear 7 is coupled to the wind direction rudder 14. Moreover, the blade spinning gear 6 is coupled to the wind direction rotation ring gear 7 via the annular teeth belt 9 so as to transmit the torque force between the revolution shaft 1 and blade spinning shafts 5. It is noted that the annular teeth belt 9 could be replaced with link chain or link gears under certain circumstances. In the meanwhile, the blade spinning shaft synchronizing gear 8 is secured onto the blade spinning shaft, and all spinning shaft synchronizing gears 8 are transmitted via the annular belt 9 to generate a synchronized movement among gears.

Furthermore, the revolution shaft 1 is rotatably disposed within the base 10 and adapted to transmit a rotation force into a generator 12 via a slant gear 11. It is noted that a stopper device 13 could be provided to the power transmission device of the present invention for managing a disengagement of the gear set. Preferably, a plurality of bearings could be provided to the blade rotation arrangement for smoothing out the overall operation of the present invention. The surface of the blade could applied with light weight materials such as canvas, gluing of materials, chemical sheet, or intensified steel web. The lining materials of the blade could applied as foam plastics. It is noted that by purposely selecting such coating and lining materials of the blade, the power transmission device could be serviceable against strong wind as well as hurricane. That is to say, when the wind intensity reaches certain degree, the coating and lining materials would be damaged first so as to protect the blade and the generator from further destroying.

According to the preferred embodiment of the present invention, the wind direction rudder is adapted to ensure that the blades of the power transmission device would be capable of providing a maximum servicing area in wind/water favorable position, and exposing a minimum bearing area in wind/water invert position. It is noted that the wind direction rudder is one of the crucial components of the passive yaw system.

It is understood that rotation or spinning of the blades refers to that blade is continuously and circularly moved with respect to the spinning shaft. On the other hand, the revolution of the blades refers to the power transmission frame wheel as well as the blades provided thereon moved continuously and circularly moved with respect to the revolution shaft. In other words, the blades provided at outside edges moved around the revolution shaft like the Earth moved around the Sun, while the blades are self-spinning at the same time. It is noted that the rotation of the blades will ultimately drive the revolution shaft into rotation in practices.

In other words, the blade is adapted to spin by itself with respect to the spinning shaft, whereas the power transmission frame wheel is adapted to rotate with respect to the revolution shaft.

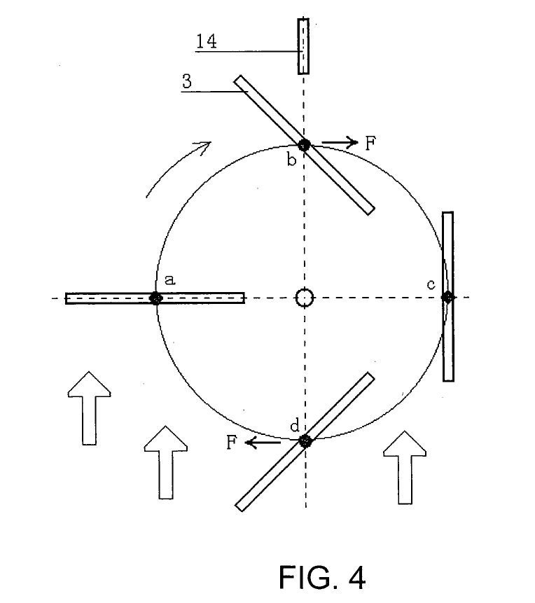

As shown in FIG. 1 and FIG. 4, the wind direction rotation ring is adapted to be freely rotated with respect to the revolution shaft depending on the wind direction and wind direction rudder. Whenever the wind direction is fixed, the wind direction rudder ring would be relative stable. That is to say, when the blade is rotating with respect to the revolution shaft, the blade as well as the blade spinning shaft are continuously and circularly moved around the wind direction rudder rotation ring. Since the wind direction rudder ring is static, and power transmitting means are provided between the blade spinning shaft and the wind direction rudder ring, the rotation of the blade spinning shaft will be transmitted into the wind direction rudder ring with a ration 1:2 with a same rotation direction. As a result, if the power transmission frame wheel is rotated around the revolution shaft with a clockwise manner, the blade would spin with a counter-clockwise manner. On the other hand, whenever the power transmission frame wheel 2 is rotated around the revolution shaft 1 with a counter-clockwise manner, the blade 3 would spin with a clockwise manner. That is to say, whenever the blade is rotate around the revolution shaft, the self-spinning blade would be inversely spinning with a 1:2 rotation ratio thus alleviating the variance of the wind bearing angle. In other words, when the blade is positioned at the maximum wind bearing position and minimum wind bearing position, the tilt angle of the spinning blade would be desirable to reducing the wind bearing force.

And more importantly, such kind of blade would generate other functional effect. Compared with conventional blade, which is incapable of generating power transmitting effect on points such as ‘a’, ‘b’ as shown in FIG. 4, the blades in the present invention would generate component force F along the circumferential tangent direction, therefore intensifying the blade moving efficiency. Due to the fact that the rotation speed ratio is 1:2, after the blade rotate 180° degree against the wind to be positioned to the upwind side, the self-spinning shaft of the blade would be rotated with half of that degree, i.e. 90° degree, such that the surface of the blade would be parallel with the wind direction to reach the minimum wind bearing size.

As shown in FIG. 4, the rotation of the blade is presumably clockwise, wherein the wind direction is marked as a thickened arrow. It is seen that when the blade is positioned at ‘a’ point, the surface of the blade is perpendicular with the wind direction rudder surface, i.e. perpendicular with the wind direction, therefore, the wind bearing area is maximized and the whole power transmission frame wheel is under the greatest torque and rotating force. While blade is rotated into a section between ‘a’ and ‘b’ point, the self-spinning reversed movement would reduce the variance of the wind bearing angle of the blade, thus increasing the upwind performance and time period. When the blade is moved to ‘b’ point, which has been proven fail to generate power efficiency in conventional blade. According to the present invention, the surface of the blade is 45° degree angled with wind direction rudder surface, the component force generated from the wind force would be along revolution circle tangent line thus facilitating the power transmission frame wheel rotated with a clockwise manner. When the blade is moved to a section between ‘b’ and ‘c’ point, the component force would be still existed at ‘b’ point, but be gradually weakened. When the blade is moved to ‘c’ point, the blade surface would be parallel with the wind direction rudder surface, the upwind surface of the blade would be substantially minimized. When the blade is moved to a section between ‘c’ and ‘d’ point, the component force at ‘b’ point is still effective and gradually strengthened. When the blade is moved to d point, which is also ineffective area in conventional blade, a similar component force would be generated with clockwise manner. When the blade is moved to a section between ‘d’ and ‘a’ point, the blade is entered into the wind bearing area with a 45° degree, therefore the force bearing point is gradually adjacent to ‘a’ point until the force reach its maximum value with a cycled manner. Conclusively, the blade at ‘a’, ‘b’, ‘c’, and ‘d’ points all show effective performance.

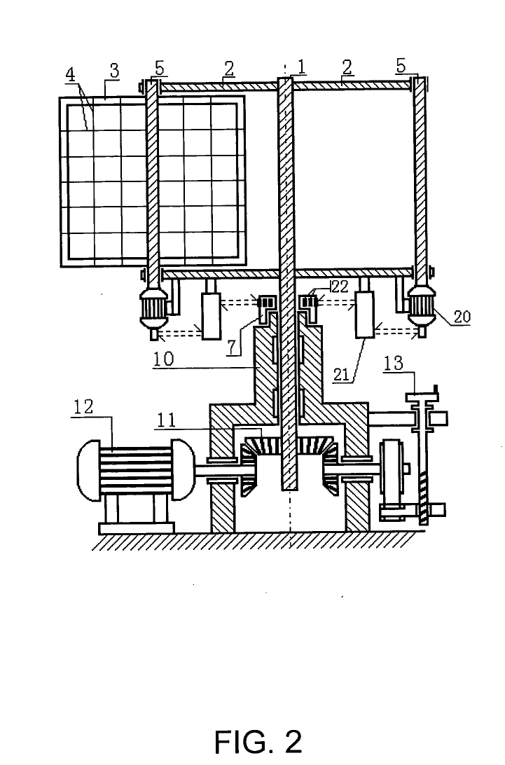

Referring to FIG. 2, the second preferred embodiment of the present invention is illustrated. The power transmission means is embodied as a self-spinning control device, which comprises a self-spinning motor coupled to the blade self-spinning shaft, and a velocity sensor for detecting the revolution speed of the revolution shaft, wherein the velocity sensor is electrically or wirelessly connected to the self-spinning motor. The self-rotating control device is adapted to manage the rotating speed and direction of the blade spinning shaft and to ensure the rotation direction of such blade spinning shaft is reversed with the rotation direction of the revolution shaft with a speed ratio 1:2.

Furthermore, as shown in FIG. 2, the main body of the wind power transmission device has an identical structure with the device shown in FIG. 1, wherein the difference is that the rotation controlling means of the power transmission device comprises a rotation rotor 20 coupled to the blade spinning shaft, and a velocity sensor adapted for measuring the revolutional speed of the revolution shaft, wherein the base of the rotation motor 20 is mounted onto the lower frame of the power transmission frame wheel and disposed inside the blade spinning shaft, and the output of the rotation motor is directly or indirectly connected with the blade spinning shaft. The wind direction rudder rotational ring gear 7 is securely mounted onto the base pole 10, therefore, the gears disposed within the wind direction rudder gear 7 could be eliminated in practice. On the other hand, a revolution speed identifying marker 22 is correspondingly disposed therein, and the revolution speed sensor 21 is mounted at the lower frame of the power transmission frame wheel 2, and at a position between rotational motor 20 and the revolutional speed trailing identifying marker 22. Or otherwise, the velocity sensor 21 is directly provided onto the base of the rotational motor 20. Moreover, the operational method could be embodied as asynchronous machine operational procedure, or wireless remote tracing, or identifying system based on the laser techniques. The above mentioned revolution speed sensor is adapted to receive the message transmitted from the revolution speed trailing indentifying marker 22, and then instruct the rotational motor into rotation with a reversed direction with respect to the revolution direction of the power transmission frame wheel, and with a speed ratio 1:2, wherein the trailing and instructing means are enabled via wire or wireless means. It is understood that certain errors would be existed within an operational cycle. However, the errors accumulation would be prohibited in the whole operational cycle.

Accordingly, the characteristic virtue of the of the present invention is that the rotational motor is effectively combined with the speed sensor, which in turn replace the conventional yawing system in wind generation device. Such assembly effectively combined the speed sensor and the motor together and is relatively simple in practice. As a result, the yawing device of conventional wind generator could be replaced, and only the wind direction vane is reserved. Here, the wind vane is the sensor of conventional yawing system, which is adapted to transmit the wind signal to the revolution speed sensor 21, afterwards, the revolution speed sensor 21 will process the revolution information and the wind direction information to instruct the rotational motor into action. Accordingly, the speed regulation device could be well combined with the revolution speed sensor, such that when the revolution sensor received regulating instruction from the speed regulation, it will correspondingly generate an active yawing to regulate the speed.

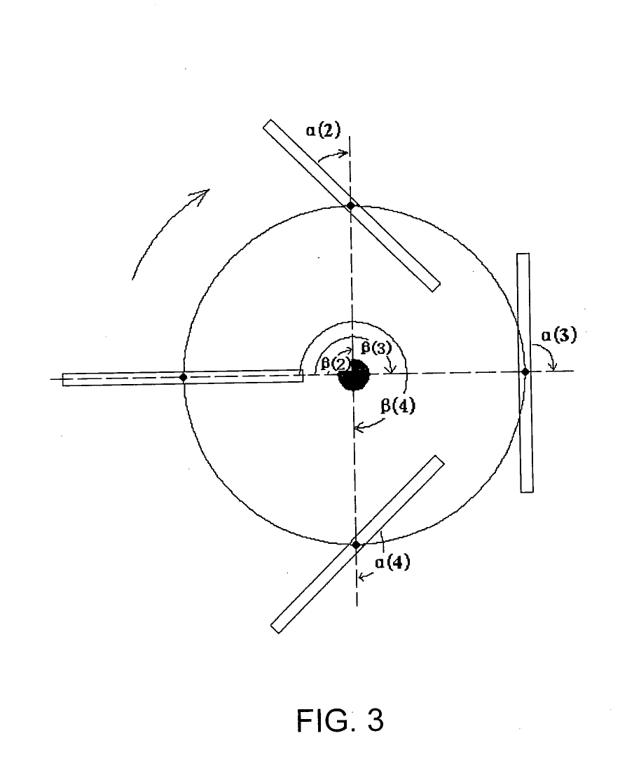

Referring to FIG. 3, the initial phase angle regulating mechanism is illustrated. According to the preferred embodiment, the power transmission device comprises four blades arranged with spaced manner respectively at four corners. First of all, the power transmission device comprises n blades, wherein n=4. Secondly, one blade is defined as a first blade, which is disposed with a clockwise manner as shown in the FIG. 3(whenever the blade is utilized as to transfer wind or hydraulic power, the clockwise direction is same with the rotation direction; on the other hand, the rotation direction could be reversed in practice) the subsequent blades are respectively defined as 2^{nd}, 3^{rd}, and 4^{th} blade. Afterwards, the spinning shaft of the first blade and spinning shaft of the any blade could be formed as an angle as a revolution angle β (i), wherein 1<=i<=n, 0°<=β(i)<=360°; In the meanwhile, the rotation angle α (i) is defined as an angle from blade surface to the spinning shaft with respect to the revolution shaft, wherein 1<i<=n, 0°<=α(i)<=180°. Based on above analysis, if the first blade's revolution angle β (1) is 0, the second, third and fourth blade's revolution angle would be respectively 90 degree, 180 degree, and 270 degree. It is seen that the revolution angle of the different blades are determined by the number of the blades and blade distributing status. Once the quantity of the blades is ensured, the revolution angle of respective blades is predetermined. However, the rotational angle a would be correspondingly adjusted based on different situations.

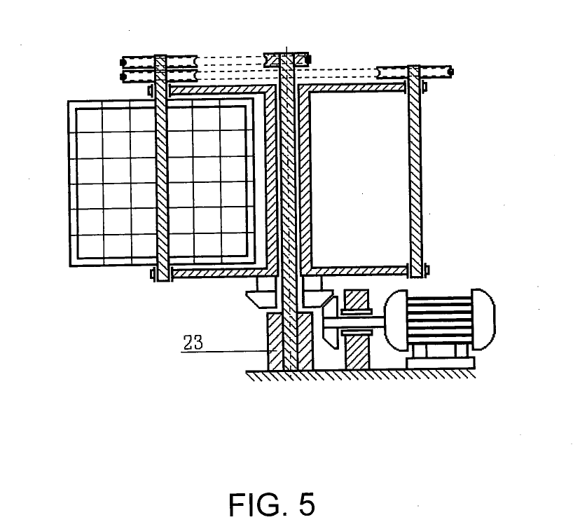

FIG. 5 illustrates the connecting relationship between the revolution shaft and power transmission frame wheel. In FIG. 1, the revolution shaft is disposed and secured within the power transmission frame wheel. In FIG. 5, the revolution shaft is moveably connected to the power transmission frame wheel, wherein the revolution shaft is mounted to the revolution shaft base 23.

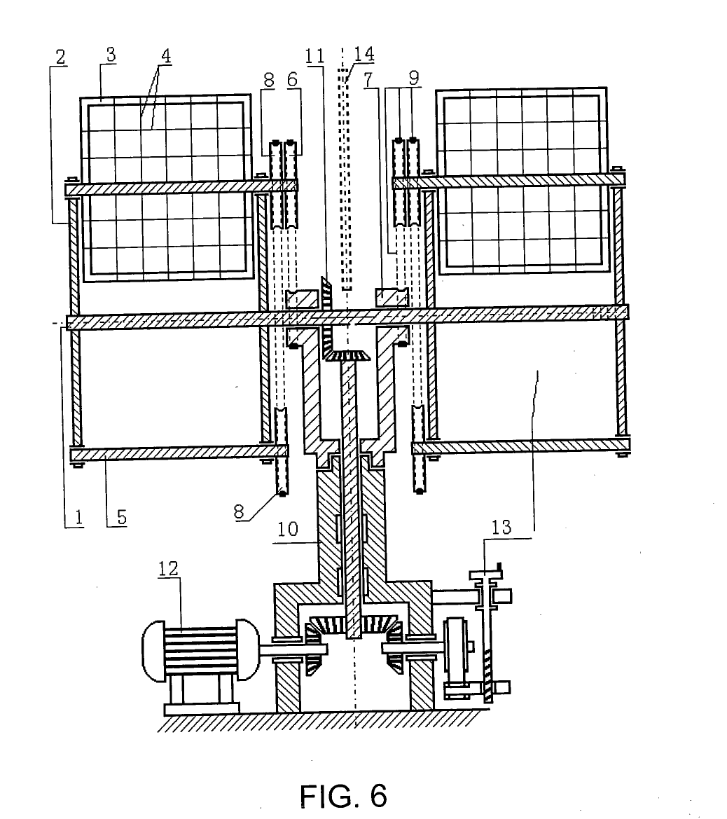

As shown in FIG. 6, the revolution shaft is parallel with the horizontal surface. As a result, the power of the wind generator could be substantially increased under the same blade intensity condition. Furthermore, the aesthetic outlook of the wind generator will be improved in practice. Thanks to the parallel structure, the blade's elevation will be varied following the motion of the power transmission frame wheel. Accordingly, in a relatively higher position, the air flow would be comparatively strong, the blade is supposed to withstand the wind positively, and in a lower position, the relatively weaker air flow is susceptible to allow blades disposed with a horizontal condition when blade go against the wind. Conclusively, such structure is capable of effectively lowering the height of the integral wind generator. What is more, the solar cell could be attached onto the blade surface, and electrical brash is mounted for directing electricity from the solar cells.

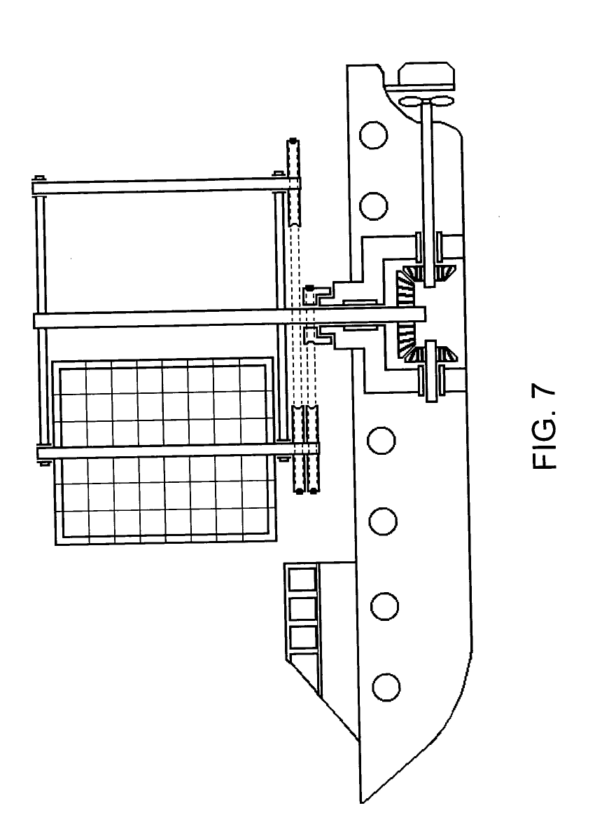

Accordingly, the power transmission device of the present invention could be utilized for driving vessels and ships. As shown in FIG. 7, the ship could be powered by wind generator, or otherwise, the ship is powered by the spiral output of the wind generator. According to the present invention, the wind generator is capable of propel the vessel regardless of the wind direction.

On the other hand, the wind energy could be converted into electrical energy via wind mill. Reversely, the electrical energy could be converted into the wind energy via blades. Since such kind of power transmission frame wheel could be embodied as a propeller for powering a vessel, such that the gear assembly could be employed. This is due to the fact that the gear assembly could be enclosed for protection purposes.

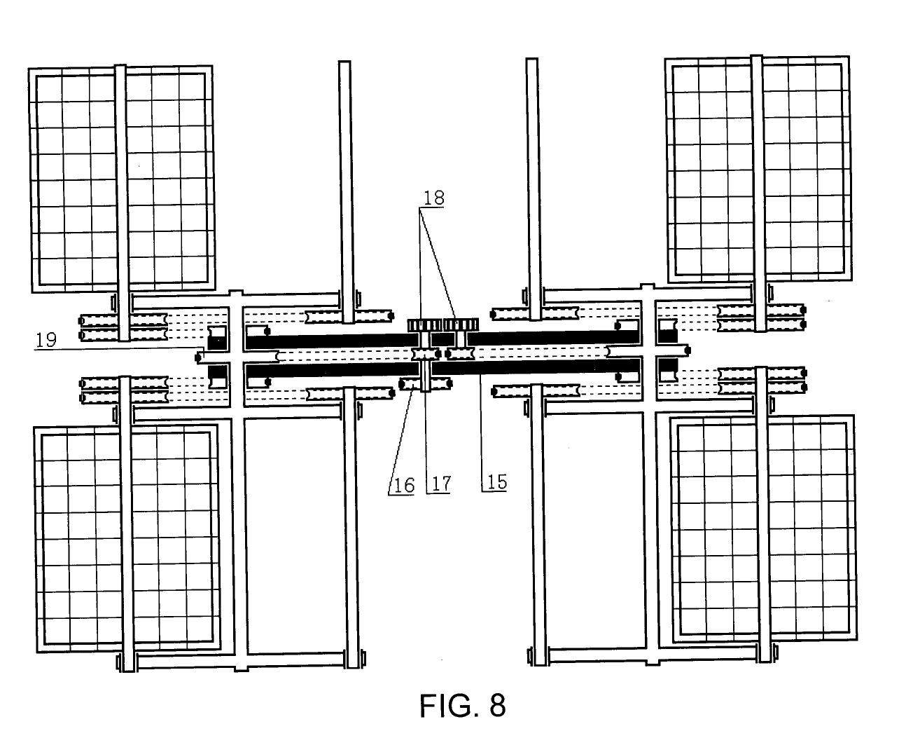

According to the preferred embodiment of the present invention, the power transmission device could be used in a flapping wing aircraft. As shown in FIG. 8, two power transmission frame wheels are symmetrically mounted onto either side of the rotational platform of the aircraft, wherein the rotational direction of two frame wheels are reversed. That is to say, the right side frame wheel is clockwise rotated while the left side frame wheel is counterclockwise rotated. The wind direction rotation ring's gear is mounted onto the rotation platform 15, such that the rotational force generated by the helicopter's engine is capable of transmitting into the gear assembly 16 and simultaneously into the coaxial gear 17 as well as the reversed gear assembly 18. As a result, the coaxial gear 17 would transmit the force into the blade revolution gear 19 via the transmission belt. Here, the blade revolution gear 19 is coupled to the blade revolution shaft 1 so as to transmit the dynamic force.

As shown in FIG. 8, the flapping wing helicopter according to the preferred embodiment of the present invention is illustrated. The cockpit is located beneath the rotation arrangement for stabilizing the weight of the helicopter and for widening the view range. The engine could be disposed at the rotational platform or provided at a lower position. It is noted that the by disposing the engine on the platform, the overall structure could be simplified. The upper portion and the lower portion of the helicopter could be embodied as a universal joint connector. As a result, the upper portion could be easily shifted with respect to the lower portion. Whenever the helicopter is taken off, the center of the gravity would be focused onto the central portion of the rotational platform. Whenever the center of the weight is dislocated, the location of the aviator would be correspondingly altered to adapt to the flying purpose. In addition, a direction rudder could be installed in the rear portion of the aviator under certain circumstances.

The traditional helicopter is operated by airscrew to generate an ascending force. On the other hand, the flapping wing helicopter employed blades assembly, which is operated with a combined way. That is to say, the blades are revolutionarily and rotationally rotated as described before. Such blade assembly is connected with the flapping wings of the aircraft, whenever the blades are shifted to two lateral sides, the blade would be parallel with the horizontal surface, the flapping wing would be downwardly flapped to generate an ascending force, and afterwards, the blades would be shifted to a position perpendicular with the horizontal surface, the rotating blades would generate a swirling ascending force to elevate the helicopter.

The blades (i.e. the wings) of the flapping wing helicopter are relatively slower in rotation. However, the surface area of the wings is relatively large such that solar cells could be easily attached thereon in either side of the wings. Therefore, the helicopter powered by supplemental solar cells would operate for a prolonged period. Such kind of aviator would be stay in the air for a while to act as scout plane. By the way, the power engine could be installed to the revolution shaft or rotational shaft according to the preferred embodiment of the present invention.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure form such principles. Therefore, this invention includes all modifications encompassed within the spirit and scope of the following claims.

What is claimed is:

1. A power transmission device, comprising:
a revolution shaft;
a power transmission frame wheel rotatably and coaxially coupled to said revolution shaft, comprising a plurality of spinning shaft symmetrically provided at outside edges of said power transmission frame;
a plural of blades rotatably and coaxially coupled to respective spinning shaft; and
a blade rotating arrangement connected to respective spinning shaft for managing a rotational direction and speed so as to ensure said spinning shafts rotated reversed with respect to said revolution shaft at a speed ratio 1:2, such that when said revolution shaft is powered to rotate driving said power transmission frame into rotation, said blades will correspondingly rotated to maximize a wind bearing size of said blade in wind favorable condition and minimize said wind bearing size in wind undesirable condition.

2. The power transmission device, as recited in claim 1, wherein said blade rotating arrangement further comprises a revolution shaft bush coaxially coupled onto said revolution shaft, a revolution gear set mounted onto said revolution shaft bush, a spinning gear set provided onto one of said spinning shaft and a plurality of spinning shaft synchronizing gear coupled onto remaining said spinning shafts, wherein said revolution gear set and said spinning gear set are transmitted via an annular teeth belt, different spinning shaft synchronic gears are transmitted via another annular teeth belt.

3. The power transmission device, as recited in claim 1, wherein said blade rotating arrangement further comprises a self-spinning motor coupled to said blade spinning shaft, and a velocity sensor for detecting a revolution speed of said revolution shaft, wherein said velocity sensor is electrically or wirelessly connected to said self-spinning motor.

4. The power transmission device, as recited in claim 1, wherein each of said blades is attached with solar cells.

5. A wind generating system, comprising:
a generator having an actuating power shaft; and
a power transmission device having a power output end coupled to said generator, comprising:
a revolution shaft;
a power transmission frame wheel rotatably and coaxially coupled to said revolution shaft, comprising a plurality of spinning shaft symmetrically provided at outside edges of said power transmission frame;
a plural of blades rotatably and coaxially coupled to respective spinning shaft; a blade rotating arrangement connected to respective spinning shaft for managing a rotational direction and speed so as to ensure said spinning shafts rotated reversed with respect to said revolution shaft at a speed ratio 1:2, such that when said revolution shaft is powered to rotate driving said power transmission frame into rotation, said blades will correspondingly rotated to maximize a wind bearing size of said blade in wind favorable condition and minimize said wind bearing size in wind undesirable condition.

6. The wind generating system, as recited in claim 5, wherein said blade rotating arrangement further comprises a revolution shaft bush coaxially coupled onto said revolution shaft, a revolution gear set mounted onto said revolution shaft bush, a spinning gear set provided onto one of said spinning shaft and a plurality of spinning shaft synchronizing gear coupled onto remaining said spinning shafts, wherein said revolution gear set and said spinning gear set are transmitted via an annular teeth belt, different spinning shaft synchronic gears are transmitted via another annular teeth belt.

7. The wind generating system, as recited in claim 5, wherein said blade rotating arrangement further comprises a self-spinning motor coupled to said blade spinning shaft, and a velocity sensor for detecting a revolution speed of said revolution shaft, wherein said velocity sensor is electrically or wirelessly connected to said self-spinning motor.

8. The wind generating system, as recited in claim 5, wherein said each of said blades is attached with solar cells.

9. The wind generating system, as recited in claim 5, is operated by the following steps:
(a) adjusting a spinning angle of a first blade into zero degree;
(b) subsequently adjusting spinning angle of remaining said spinning blades so as to enable said spinning angle α of said remaining spinning blades half as much as a revolution angle β; and
(c) enabling a surface of said blade perpendicular with a wind direction.

10. A flapping wing helicopter, comprising:
a helicopter body;
a pair of flapping wing respectively and longitudinally provided at either side of said helicopter body for providing said helicopter a propelling power, wherein said flapping wing comprises:
a revolution shaft;
a power transmission frame wheel rotatably and coaxially coupled to said revolution shaft, comprising a plurality of spinning shaft symmetrically provided at outside edges of said power transmission frame;
a plural of blades rotatably and coaxially coupled to respective spinning shaft; a blade rotating arrangement connected to respective spinning shaft for managing a rotational direction and speed so as to ensure said spinning shafts rotated reversed with respect to said revolution shaft at a speed ratio 1:2, such that when said revolution shaft is powered to rotate driving said power transmission frame into rotation, said blades will correspondingly rotated to maximize a wind bearing size of said blade in wind favorable condition and minimize said wind bearing size in wind undesirable condition.

11. The flapping wing helicopter, as recited in claim 10, said blade rotating arrangement further comprises a revolution shaft bush coaxially coupled onto said revolution shaft, a revolution gear set mounted onto said revolution shaft bush, a spinning gear set provided onto one of said spinning shaft and a plurality of spinning shaft synchronizing gear coupled onto remaining said spinning shafts, wherein said revolution gear set and said spinning gear set are transmitted via an annular teeth belt, different spinning shaft synchronic gears are transmitted via another annular teeth belt.

12. The flapping wing helicopter, as recited in claim 10, wherein said blade rotating arrangement further comprises a self-spinning motor coupled to said blade spinning shaft, and a velocity sensor for detecting a revolution speed of said revolution shaft, wherein said velocity sensor is electrically or wirelessly connected to said self-spinning motor.

13. The flapping wing helicopter, as recited in claim 10, wherein each of said blades is attached with solar cells.

14. The flapping wing helicopter, as recited in claim 10, is operated by the following steps:
(a) adjusting a spinning angle of a first blade into zero degree;
(b) subsequently adjusting spinning angle of remaining said spinning blades so as to enable said spinning angle α of said remaining spinning blades half as much as a revolution angle β;
(c) enabling a surface of said blade parallel with a wind direction; and
(d) rotating said revolution shaft of said power transmission device.

15. A waterpower system, comprising:
a plurality of turbines for withstanding water flow impact, wherein each of said turbines comprises:
a revolution shaft;
a power transmission frame wheel rotatably and coaxially coupled to said revolution shaft, comprising a plurality of spinning shaft symmetrically provided at outside edges of said power transmission frame;
a plural of blades rotatably and coaxially coupled to respective spinning shaft; and
a blade rotating arrangement connected to respective spinning shaft for managing a rotational direction and speed so as to ensure said spinning shafts rotated reversed with respect to said revolution shaft at a speed ratio 1:2, such that when said revolution shaft is powered to rotate driving said power transmission frame into rotation, said blades will correspondingly rotated to maximize a wind bearing size of said blade in wind favorable condition and minimize said wind bearing size in wind undesirable condition.

16. The waterpower system, as recited in claim 15, wherein said blade rotating arrangement further comprises a revolution shaft bush coaxially coupled onto said revolution shaft, a revolution gear set mounted onto said revolution shaft bush, a spinning gear set provided onto one of said spinning shaft and a plurality of spinning shaft synchronizing gear coupled onto remaining said spinning shafts, wherein said revolution gear set and said spinning gear set are transmitted via an annular teeth belt, different spinning shaft synchronic gears are transmitted via another annular teeth belt.

17. The waterpower system, as recited in claim 15, wherein said blade rotating arrangement further comprises a self-spinning motor coupled to said blade spinning shaft, and a velocity sensor for detecting a revolution speed of said revolution shaft, wherein said velocity sensor is electrically or wirelessly connected to said self-spinning motor.

18. A vessel, comprising:
a vessel body;
a propeller provided at said vessel body; and
a propeller driving system for driving said propeller, comprising:
a revolution shaft;
a power transmission frame wheel rotatably and coaxially coupled to said revolution shaft, comprising a plurality of spinning shaft symmetrically provided at outside edges of said power transmission frame;
a plural of blades rotatably and coaxially coupled to respective spinning shaft; and
a blade rotating arrangement connected to respective spinning shaft for managing a rotational direction and speed so as to ensure said spinning shafts rotated reversed with respect to said revolution shaft at a speed ratio 1:2, such that when said revolution shaft is powered to rotate driving said power transmission frame into rotation, said blades will correspondingly rotated to maximize a wind bearing size of said blade in wind favorable condition and minimize said wind bearing size in wind undesirable condition.

19. The vessel, as recited in claim 18, wherein said blade rotating arrangement further comprises a revolution shaft bush coaxially coupled onto said revolution shaft, a revolution gear set mounted onto said revolution shaft bush, a spinning gear set provided onto one of said spinning shaft and a plurality of spinning shaft synchronizing gear coupled onto remaining said spinning shafts, wherein said revolution gear set and said spinning gear set are transmitted via an annular teeth belt, different spinning shaft synchronic gears are transmitted via another annular teeth belt.

20. The vessel, as recited in claim 19, wherein said blade rotating arrangement further comprises a self-spinning motor coupled to said blade spinning shaft, and a velocity sensor for detecting a revolution speed of said revolution shaft, wherein said velocity sensor is electrically or wirelessly connected to said self-spinning motor.
